(19) United States
(12) Patent Application Publication
(10) Pub. No.: US 2025/0061282 A1
(43) Pub. Date: Feb. 20, 2025

(54) METHOD OF GENERATING TRAINING DATA, READABLE MEDIUM, AND ELECTRONIC DEVICE

(71) Applicant: Beijing Youzhuju Network Technology Co., Ltd., Beijing (CN)

(72) Inventor: Yukun MA, VANCOUVER (CA)

(21) Appl. No.: 18/784,900

(22) Filed: Jul. 25, 2024

(30) Foreign Application Priority Data
Aug. 15, 2023 (CN) 202311030154.0

(51) Int. Cl. G06F 40/30

(52) U.S. Cl. CPC G06F 40/30

(57) ABSTRACT

A method of generating training data, a readable medium and an electronic device are provided. The method includes: acquiring sample data; determining a data generation template according to the sample data; generating question data according to the first data in the sample data and the data generation template, and determining answer data according to the second data other than the first data in the sample data; and combining the question data and the answer data into the training data.

### CROSS-REFERENCE TO RELATED APPLICATION

The present application claims priority of the Chinese Patent Application No. 202311030154.0, filed on Aug. 15, 2023, which is incorporated herein by reference in its entirety as part of the present application.

### TECHNICAL FIELD

The present disclosure relates to a method of generating training data, and a readable medium and an electronic device.

### BACKGROUND

Prompt paradigm is a technology that guides language models to generate contents expected by users through natural language description, and has been widely used in the field of neuro-linguistic programming (NLP). For example, for generation models, the quality of contents obtained through prompts is greatly improved, or when large language models are guided based on the prompts to generate text contents that meet human intentions, there is a significant effect. Therefore, when a model is trained, the quality of prompts designed will affect the quality of the final output content.

High-quality guide text and result text <Prompt, Answer> are required as training sets in a training model process. Generally, the training sets are written manually, which is inefficient and costly.

### SUMMARY

The summary section is provided in order to introduce concepts in brief form, and the concepts will be described in detail in the specific embodiments section later. The summary section is not intended to identify key features or essential features of the technical solutions that are claimed for protection, nor is it intended to be used to limit the scope of the technical solutions that are claimed for protection.

The embodiments of the present disclosure provide a method of generating training data, which includes:
acquiring sample data;
determining a data generation template according to the sample data;
generating question data according to the first data in the sample data and the data generation template, and determining answer data according to the second data other than the first data in the sample data; and
combining the question data and the answer data into the training data.

The embodiments of the present disclosure provide an apparatus of generating training data, which includes an acquisition module, a template determination module, a data determination module and a combination module.

The acquisition module is configured to acquire sample data.

The template determination module is configured to determine a data generation template according to the sample data.

The data determination module is configured to generate question data according to the first data in the sample data and the data generation template, and determine answer data according to the second data other than the first data in the sample data.

The combination module is configured to combine the question data and the answer data into the training data.

The embodiments of the present disclosure provide a non-transient computer-readable medium, which stores computer programs. When the computer programs are executed by a processor, the method of generating training data provided by any one of the embodiments described above is implemented.

The embodiments of the present disclosure provide an electronic device, which includes a memory and at least one processor.

The memory stores computer programs.

The at least one processor is configured to execute the computer programs in the memory to implement the method of generating training data provided by any one of the embodiments described above is implemented.

Additional features and advantages of the present disclosure will be set forth in the detailed description which follows.

### BRIEF DESCRIPTION OF DRAWINGS

In conjunction with the drawings and with reference to the following specific embodiments, the above and other features, advantages and aspects of each embodiment of the present disclosure will become more apparent. Throughout the drawings, the same or similar drawing marks indicate the same or similar elements. It should be understood that the drawings are schematic, and the originals and elements are not necessarily drawn to scale.

FIG. 1 is a schematic diagram of generating figures based on a prompt provided in accordance with an exemplary embodiment;

FIG. 2 is a schematic diagram of generating text based on a prompt provided in accordance with an example embodiment;

FIG. 3 is a schematic flowchart of a method of generating training data provided in accordance with an exemplary embodiment of the present disclosure;

FIG. 4 is a schematic diagram of sample data provided in accordance with an exemplary embodiment of the present disclosure;

FIG. 5 is a block diagram of an apparatus of generating training data provided in accordance with an exemplary embodiment of the present disclosure; and

FIG. 6 is a block diagram of an electronic device provided in accordance with an exemplary embodiment of the present disclosure.

### DETAILED DESCRIPTION

The embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise explicitly stated in the context, it should be understood as “one or more”.

It is to be understood that before using the technical solutions disclosed in each embodiment of the present disclosure, the type, using scope, and using scenarios of the personal information involved in the present disclosure shall be informed to the user, and the authorization of the user shall be obtained through appropriate methods in accordance with relevant laws and regulations.

For example, in response to receiving an active request from a user, prompt information is sent to the user to explicitly prompt the user that operations that the user requests to execute will require acquiring and using personal information of the user. Thus, according to the prompt information, the user can autonomously select whether or not to provide personal information to software or hardware, such as an electronic device, an application program, a server or a storage medium, which performs the operations of the disclosed technical solutions.

As an alternative but non-limiting implementation, in response to receiving an active request of a user, the prompt information may be sent to the user, for example, in the form of a pop-up window, in which the prompt information may be presented in a form of text. In addition, the pop-up window may also carry a selection control for the user to select “Agree” or “Disagree” to provide personal information to the electronic device.

It is to be understood that the above-described process of informing the user and acquiring authorization of the user is merely schematic and does not limit the implementation of the present disclosure, and other methods that comply with relevant laws and regulations may also be applied to the implementation of the present disclosure.

Simultaneously, it is also to be understood that the data involved in the present technical solutions (including but not limited to the data itself and the acquisition or use of the data) shall comply with the requirements of corresponding laws and regulations and relevant provisions.

As noted in the background, when training a model, the quality of the designed prompt will affect the quality of the final output content. For example, referring to FIG. 1, by designing different prompts, an artificial intelligence (AI) drawing generation tool are used to generate pictures based on text contents of the prompts, the obtained pictures are significantly different. Pictures generated with simple prompts tend to be rough, while the contents generated with more detailed prompts have higher quality, not only including a lot of details, but also being clearer.

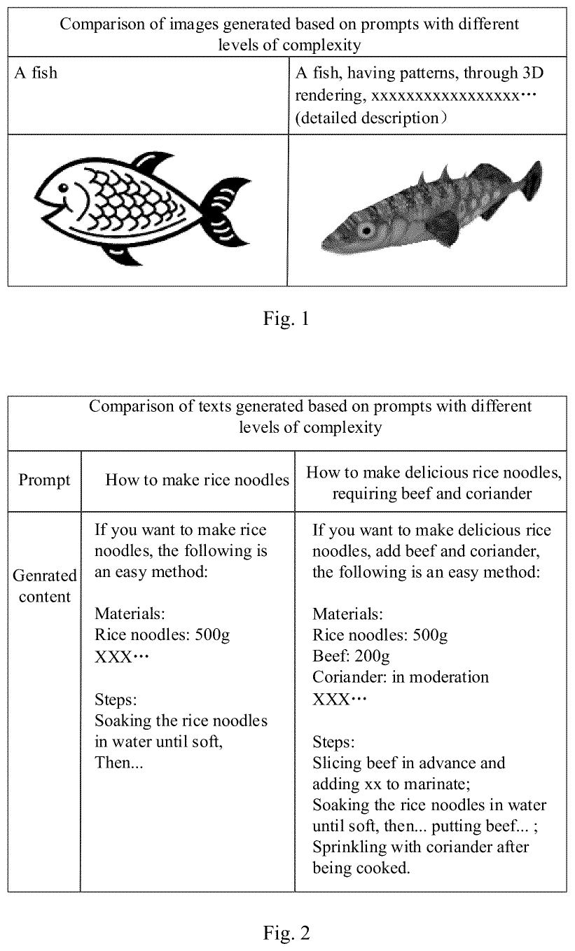

In addition, with respect to the training corpus of a text generation model, referring to FIG. 2, when the text generation model is asked how to make rice noodles with beef and coriander, the generated content needs to include the two food materials, otherwise the generated content does not meet the intention of the user. Usually, in order to enable a model to generate contents (including texts, pictures, audios, etc.) with higher quality, careful adjustment and elaborate design of prompts is required, and the design process is called prompt engineering.

With the development of computer technology, a large number of related contents in different vertical domains are accumulated, including documents, tables and other contents in different formats. Annotators usually need to first read and understand the contents in the vertical domains, then design the prompts and write the generated contents manually, and finally use these manually written contents to train a content generation model, thereby obtaining content generation models for different vertical domains, which is not only inefficient but also costly.

In view of the above, the present disclosure provides a method and apparatus of generating training data, a readable medium, and an electronic device to solve the above-described problems.

The embodiments of the present disclosure will be further explained below with reference to the accompanying drawings.

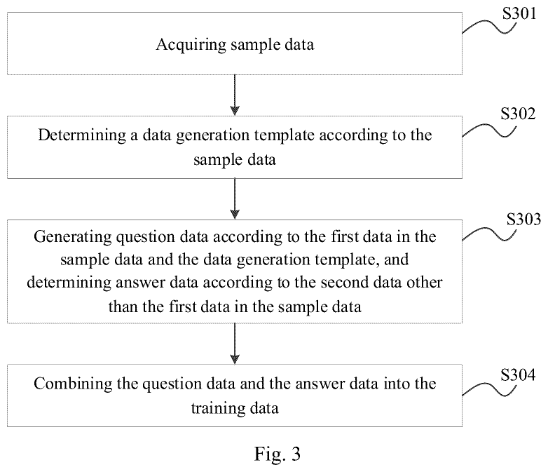

FIG. 3 is a schematic flowchart of a method of generating training data according to an exemplary embodiment of the present disclosure. Referring to FIG. 3, the method includes S301-S304.

S301: acquiring sample data.

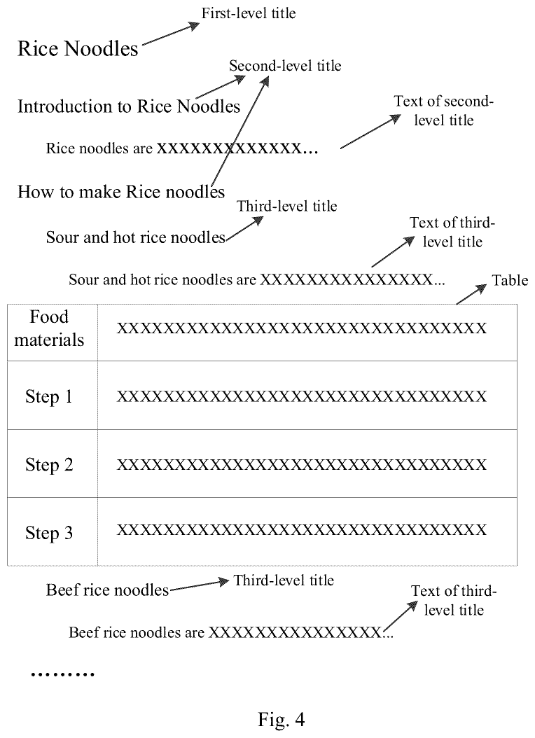

In S301, the sample data is knowledge data of a target knowledge domain (vertical domain), and may include tabular data or text data, such as a document for making rice noodles as shown in FIG. 4. The generated training data is used for training a general text generation model to obtain a target text generation model in the target knowledge domain.

S302: determining a data generation template according to the sample data.

S303: generating question data according to the first data in the sample data and the data generation template, and determining answer data according to the second data other than the first data in the sample data.

S304: combining the question data and the answer data into the training data.

With the above-described method, the data generation template can be determined based on the sample data, and then the training data including the question data and the answer data can be automatically generated. The method is simple to implement and does not require manual writing, which improves the efficiency of model training and reduces costs, and does not introduce data noise caused by manual writing into the training data, which reduces the interference to model training and further improves the efficiency of model training.

It is worth noting that the prompt design required for the training set needs to follow some basic principles: the description of concepts or steps needs be specific to corresponding knowledge blocks, and as detailed as possible (concretization); whether the explanation of concepts or the elaboration of steps should be defined as clearly as possible (clarification); as far as possible, one prompt involves only one question, and does not involve open or broad commands or questions (focusing); and the definition of a prompt and the answer content should describe the same topic, but cannot be misplaced (relevance).

Therefore, based on the above principles and the sample data shown in FIG. 4, some questions can be extracted and can be matched with corresponding answers so that the model learns knowledge of a certain vertical domain based on the questions and answers. The questions generally include:
1. What: generally with respect to the explanation and definition of concepts;
2. How: generally with respect to the explanation and steps of operations;
3. Where: generally a regional question;
4. When: a question with respect to time or date; and
5. Why: a question with respect to the reason.

In general, the answer to How in the contents of a vertical domain may include the answer to Why, and thus either How or Why may be devoted to, which may be configured as desired, and is not limited herein.

In a possible implementation, the determining a data generation template according to the sample data, may include: when the sample data includes tabular data, determining the data generation template according to arrangement information of data in the tabular data. When the sample data includes text data, determining the data generation template by at least one selected from the group consisting of: performing semantic recognition on the sample data to obtain a semantic recognition result, and determining the data generation template according to the semantic recognition result; and performing entity recognition on the sample data through a preset entity recognition model to obtain an entity recognition result, and determining the data generation template according to the entity recognition result.

For example, referring to FIG. 4, the sample data may include text data, and may also include tabular data. With respect to the tabular data, the data generation template may be determined according to arrangement information of data in the tabular data. With respect to the text data, semantic recognition or entity recognition may be performed on the sample data, and the data generation template is determined based on a semantic recognition result or an entity recognition result, so that the data generation template can be determined based on sample data in different formats, thereby improving the processing capability of converting the sample data into the training data.

In a possible implementation, the determining the data generation template according to the semantic recognition result, may include: searching for at least one data generation template carrying the first template identifier in a preset template library according to the semantic recognition result, wherein the preset template library pre-stores a plurality of the data generation templates, and the first template identifier is a preset template identifier matching the semantic recognition result. Determining the data generation template according to the entity recognition result may include: searching for at least one data generation template carrying a second template identifier in the preset template library according to the entity recognition result, wherein the second template identifier is a preset template identifier matching the entity recognition result.

For example, the preset template library may include the plurality of the data generation templates, including data generation templates corresponding to the above-described What, How, Where, When and Why, which may be “What is {recognition result 1}?”, “How to {recognition result 2}?”, and so on. The corresponding template identifiers may be time, place, noun explanation, step, etc. In general, a template identifier characterizing a noun may match a template for noun explanation (What), and a template identifier characterizing a verb may match a template for step explanation (How), which may be specifically configured as desired, and is not limited herein.

For example, the text data includes “The starting point of the Great Wall is Shanhaiguan, the ending point is Jiayuguan, and the whole length is XX kilometers from cast to west via A, B, C”, and the semantic recognition result may include “the starting point of the Great Wall is Shanhaiguan”, “the ending point of the Great Wall is Jiayuguan”, etc. A template related to location may be matched according to the location identifier, for example, the question is “Where is the starting point of the Great Wall?”, and the answer is “The starting point of the Great Wall is Shanhaiguan”, etc., which is not limited herein.

For another example, the text data includes “A rose is a plant of the Rosaceae family”, the entity “rose” is recognized based on an entity recognition model, and a template related to noun explanation may be matched according to the noun explanation identifier, for example, the question is “What is a rose?”, and the answer is “A rose is a plant of the Rosaceae family”, etc., which is not limited herein.

Thus, the data generation template may be determined according to the semantics or entities of the sample data, thereby improving the processing capacity of converting sample data into the training data. In addition, the above-described semantic recognition and entity recognition may be implemented by corresponding tools or models, and the specific implementation is not limited therein, as long as the functions of semantic recognition or entity recognition can be realized.

In a possible implementation, determining the data generation template according to arrangement information of data in the tabular data, may include: determining a question template for acquiring a concept explanation content as the data generation template with respect to any of the following data of the tabular data: a table name, the first row data, and the first column data; and determining a question template with a condition as the data generation template with respect to non-first row data other than the table name or non-first column data other than the table name in the tabular data.

For example, still referring to FIG. 4, the tabular data has some features, the table name, the column name (or the first column data) and the row name (or the first row data) are equivalent to questions, and the corresponding table content, the content of the same row other than the first column or the content of the same column other than the first row are equivalent to answers. For example, the table name may be directly taken as the prompt, and the answer is the content of the table. Alternatively, the first row or column of the table may be queried using What, Which, etc., and the answer is the content below the first row or the content after the first column. For example, a question template “What is {table name}?”, for example, the prompt is “What are food materials for making sour and hot rice noodles?”, and the answer is data in the first row of the table other than the food material column. Therefore, the features of the tabular data can be used to determine the data generation template, thereby improving the processing capacity of converting the sample data into the training data.

For example, with respect to non-first row data or non-first column data of the table, a question with a condition may be used, for example, the prompt is “What is {column3} when {column1_name} is {xxx} and {column2_name} is {xxx}?”, and the answer is the content where column3 is located. Thus, a large amount of question and answer data can be generated through the change of conditions.

In a possible implementation, determining a data generation template according to the sample data, may include: when the first data in the sample data is a title, determining the first data generation template, wherein the first data generation template is a question template for acquiring an explanation content of the first data. Determining answer data according to second data other than the first data in the sample data, may include: taking a directory content corresponding to the sample data or an abstract content located after the first data in the sample data as the answer data.

For example, referring to FIG. 4, document titles and document subtitles (sections) may first be focused on. For the document titles (e.g., first-level titles), a <Prompt, Answer> pair may be constructed by extracting the abstract or outline of the document, for example, the prompt is “What are rice noodles?”, and the answer is “Rice noodles are xxx . . . , including sour and hot rice noodles, beef rice noodles, and many other flavors”.

Alternatively, for purely nominal subtitles may be queried with the question “What is”, typically for some conceptual question explanation. For example, the prompt template may be designed as “What is {subtitle 1}?”, or “What is the definition of {subtitle 1}?”, etc., which is not limited herein. Accordingly, the answer is the content under the subtitle, for example, the prompt is a second-level title, and the answer is the text of the second-level title.

For example, titles starting with a verb may be queried with the question “How to”, typically for some answers related to operations and implementation. For example, the prompt template may be designed as “How to make {title}?”, or “Give me the instruction to make {title}”, etc., which is not limited herein.

Therefore, the data generation template may be determined according to the titles in the sample data, and then the answer data is determined, thereby not only improving the generation efficiency of training data, but also enhancing the diversity of prompts.

In a possible implementation, determining a data generation template according to the sample data, may include: when the first data in the sample data is a concept entity, determining the second data generation template. The second data generation template is a question template for acquiring an explanation content of the first data. Determining answer data according to second data other than the first data in the sample data, may include: determining the answer data according to a context content of the first data in the sample data.

For example, entities in the text may also be focused on. The entity in the text may be recognized and queried about the concept, and the context in which the entity resides is taken as the answer. For example, some sample data may not include title contents, or when there is a concept entity unrelated to the title in the body of the title, the question template “What is {concept entity}?” may be determined directly according to the concept entity in the sample data, and the answer data is determined according to the context. For example, with respect to the text of the second-level title in FIG. 4, a concept “rice noodles” can be recognized through an entity recognition model, and the text is an explanation of the concept. Therefore, the prompt may be the entity, and the answer is the text.

For another example, the sample data is “xx seasoning (including a mixed seasoning of H, M and N) can be added to add flavor when making rice noodles”, from which a concept entity “xx seasoning” is recognized, and the prompt can be constructed as “What is xx seasoning?”, and the answer is “xx seasoning is a mixed seasoning of H, M and N”.

Therefore, the data generation template may be determined according to the entity in the text of the sample data, and then the answer data is determined, thereby enriching the sources of prompts and enhancing the diversity of prompts.

In a possible implementation, determining a data generation template according to the sample data, may include: when the second data in the sample data is arrayed data, determining the third data generation template, wherein the third data generation template is a question template for acquiring the arrayed data; and correspondingly, the first data is data located before the second data in the sample data.

For example, bullet points may also be focused on. The content of a previous sentence may be converted into a question or statement, for example, “Show me the type list of {subtitles}”, or “Give me all the types that belong to {subtitles}”, etc., which is not limited herein.

For example, referring to the arrayed data of the step 1, step 2, and step 3 of making sour and hot rice noodles in FIG. 4, the question template may be a question template for acquiring the steps of making sour and hot rice noodles. For example, the prompt may be constructed as “How to make sour and hot rice noodles?”, and the answer is the contents of the step 1, step 2 and step 3. Therefore, the data generation template may be determined according to data in a special format, and then the answer data is determined, thereby enhancing the diversity of prompts.

It is worth noting that the same sample data may match a plurality of templates to obtain a plurality of pieces of training data. Still referring to FIG. 4, training data may be acquired, for example, training data 1: “What are rice noodles?”, “Rice noodles are xxx”; training data 2: “What is sour and hot rice noodles?”, “Sour and hot rice noodles are xxx”; training data 3: “What are the flavors of rice noodles?”, “Sour and hot rice noodles, and beef rice noodles”; training data 4: “How to make sour and hot rice noodles?”, “The contents of step 1, step 2 and step 3”, etc. Therefore, based on the data generation template, the knowledge data of the vertical domain is quickly and automatically transformed into structured and numerous training data, and the text generation model can learn the knowledge of the vertical domain through the training data, thereby better covering and answering the questions of users.

The above-described method not only saves the manpower costs of manually writing <Prompt, Answer> pairs, but also automatically generates the <Prompt, Answer> pairs covering the contents of the vertical domain, which improves the generation efficiency of the training data for the text generation model. Furthermore, the diversity of prompts is enhanced by designing templates flexibly, and the generation effect of the text generation model in the vertical domain is enhanced. In addition, the generated <Prompt, Answer> pairs are used to train the text generation model, so as to inject domain knowledge into the model. This method of transforming the text or table into <Prompt, Answer> pairs enables a general model to obtain sufficient high-quality training data when the general model is applied to a certain vertical domain, and the method is easy to implement and does not introduce data noise caused by manual writing into the training data, thereby reducing the interference to model training, and further improving the efficiency of model training.

It is worth noting that the present disclosure provides not only a method for automatically generating a prompt data set corresponding to sample data (including text or table content) based on templates, but also a tool for generating the prompt data set in a programmed manner. In addition, the method of generating training data provided by the present disclosure may be used to generate training data for a text generation model to train the text generation model, and may also be used to generating training data for a picture generation model to train the picture generation model, which is not limited herein. In the process of generating training data for the picture generation model, the text content is the prompt, and the picture content is the answer, for example, the context content in a document including template pictures is taken as the prompt, and a target picture is taken as the answer.

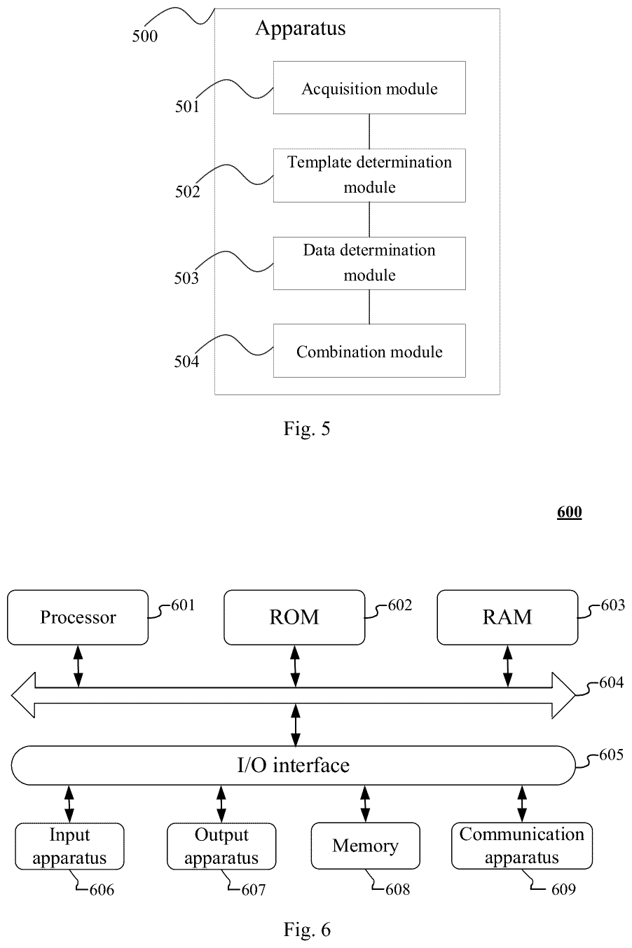

Based on the same concept, the present disclosure provides an apparatus of generating training data. Referring to FIG. 5, the apparatus 500 includes an acquisition module 501, a template determination module 502, a data determination module 503 and a combination module 504.

The acquisition module 501 is configured to acquire sample data.

The template determination module 502 is configured to determine a data generation template according to the sample data.

The data determination module 503 is configured to generate question data according to the first data in the sample data and the data generation template, and determine answer data according to the second data other than the first data in the sample data.

The combination module 504 is configured to combine the question data and the answer data into the training data.

With the above-described method, the data generation template can be determined based on the sample data, and then the training data including the question data and the answer data can be automatically generated. The method is simple to implement and does not require manual writing, which improves the efficiency of model training and reduces costs, and does not introduce data noise caused by manual writing into the training data, which reduces the interference to model training and further improves the efficiency of model training.

Optionally, the template determination module 502 includes the first determination submodule and the second determination submodule.

The first determination submodule is configured to, when the sample data includes tabular data, determine the data generation template according to arrangement information of data in the tabular data.

The second determination submodule is configured to, when the sample data includes text data, determine the data generation template by at least one selected from the group consisting of:
performing semantic recognition on the sample data to obtain a semantic recognition result, and determining the data generation template according to the semantic recognition result; and
performing entity recognition on the sample data through a preset entity recognition model to obtain an entity recognition result, and determining the data generation template according to the entity recognition result.

Optionally, the second determination submodule is configured to search for at least one data generation template carrying the first template identifier in a preset template library according to the semantic recognition result, wherein the preset template library pre-stores a plurality of the data generation templates, and the first template identifier is a preset template identifier matching the semantic recognition result; and
the second determination submodule is configured to search for at least one data generation template carrying the second template identifier in the preset template library according to the entity recognition result, wherein the second template identifier is a preset template identifier matching the entity recognition result.

Optionally, the first determination submodule is configured to:
determine a question template for acquiring a concept explanation content as the data generation template with respect to any of following data of the tabular data selected from the group consisting of: a table name, first row data, and first column data; and
determine a question template with a condition as the data generation template with respect to non-first row data other than the table name or non-first column data other than the table name in the tabular data.

Optionally, the template determination module 502 is configured to, when the first data in the sample data is a title, determine the first data generation template, wherein the first data generation template is a question template for acquiring an explanation content of the first data; and
the data determination module 503 is configured to take a directory content corresponding to the sample data or an abstract content located after the first data in the sample data as the answer data.

Optionally, the template determination module 502 is configured to, when the first data in the sample data is a concept entity, determine the second data generation template, wherein the second data generation template is a question template for acquiring an explanation content of the first data; and
the data determination module 503 is configured to determine the answer data according to a context content of the first data in the sample data.

Optionally, the template determination module 502 is configured to determine the third data generation template when the second data in the sample data is arrayed data, wherein the third data generation template is a question template for acquiring the arrayed data; and correspondingly, the first data is data located before the second data in the sample data.

Specific manners of operations performed by the modules in the apparatus in the above embodiment have been described in detail in the embodiments regarding the method, which will not be explained and described in detail herein again.

Based on the same conception, the embodiments of the present disclosure further provide a non-transient computer-readable medium, which stores computer programs. When the computer programs are executed by a processor, the steps of the above method of generating training data are implemented.

Based on the same conception, the embodiments of the present disclosure further provide an electronic device, which includes a memory and at least one processor. The memory stores computer programs. The at least one processor is configured to execute the computer programs in the memory to implement the steps of the above method of generating training data.

FIG. 6 is referred below, which shows the structural schematic diagram suitable for achieving the electronic device 600 in the embodiments of the present disclosure. The electronic device 600 in the embodiments of the present disclosure may include but not be limited to a mobile terminal such as a mobile phone, a notebook computer, a digital broadcasting receiver, a personal digital assistant (PDA), a PAD (tablet computer), a portable multimedia player (PMP), a vehicle terminal (such as a vehicle navigation terminal), and a fixed terminal such as a digital television (TV) and a desktop computer. The electronic device shown in FIG. 6 is only an example and should not impose any limitations on the functions and use scopes of the embodiments of the present disclosure.

As shown in FIG. 6, the electronic device 600 may include a processor (such as a central processing unit, and a graphics processor) 601, it may execute various appropriate actions and processes according to a program stored in a read-only memory (ROM) 602 or a program loaded from a memory 608 to a random access memory (RAM) 603. In RAM 603, various programs and data required for operations of the electronic device 600 are also stored. The processor 601, ROM 602, and RAM 603 are connected to each other by a bus 604. An input/output (I/O) interface 605 is also connected to the bus 604.

Typically, the following apparatuses may be connected to the I/O interface 605: an input apparatus 606 such as a touch screen, a touchpad, a keyboard, a mouse, a camera, a microphone, an accelerometer, and a gyroscope; an output apparatus 607 such as a liquid crystal display (LCD), a loudspeaker, and a vibrator; a memory 608 such as a magnetic tape, and a hard disk drive; and a communication apparatus 609. The communication apparatus 609 may allow the electronic device 600 to wireless-communicate or wire-communicate with other devices so as to exchange data. Although FIG. 6 shows the electronic device 600 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 609, or installed from the memory 608, or installed from ROM 602. When the computer program is executed by the processor 601, the above functions defined in the method of the embodiments of the present disclosure are executed.

It should be noted that the above-mentioned computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a Hyper Text Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-mentioned computer-readable medium may be included in the above-mentioned electronic device, or may also exist alone without being assembled into the electronic device.

The above-mentioned computer-readable medium carries one or more than one programs. When the one or more than one programs are executed by the electronic device, the electronic device is caused to: acquire sample data; determine a data generation template according to the sample data; generate question data according to the first data in the sample data and the data generation template, and determine answer data according to the second data other than the first data in the sample data; and combine the question data and the answer data into the training data.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A method of generating training data, comprising:
acquiring sample data;
determining a data generation template according to the sample data;
generating question data according to first data in the sample data and the data generation template, and determining answer data according to second data other than the first data in the sample data; and
combining the question data and the answer data into the training data.

2. The method according to claim 1, wherein the determining a data generation template according to the sample data, comprises:
when the sample data comprises tabular data, determining the data generation template according to arrangement information of data in the tabular data;
when the sample data comprises text data, determining the data generation template by at least one selected from the group consisting of:
performing semantic recognition on the sample data to obtain a semantic recognition result, and determining the data generation template according to the semantic recognition result; and
performing entity recognition on the sample data through a preset entity recognition model to obtain an entity recognition result, and determining the data generation template according to the entity recognition result.

3. The method according to claim 2, wherein the determining the data generation template according to the semantic recognition result, comprises:
searching for at least one data generation template carrying a first template identifier in a preset template library according to the semantic recognition result, wherein the preset template library pre-stores a plurality of the data generation templates, and the first template identifier is a preset template identifier matching the semantic recognition result; and
the determining the data generation template according to the entity recognition result, comprises:
searching for at least one data generation template carrying a second template identifier in the preset template library according to the entity recognition result, wherein the second template identifier is a preset template identifier matching the entity recognition result.

4. The method according to claim 2, wherein the determining the data generation template according to arrangement information of data in the tabular data, comprises:
determining a question template for acquiring a concept explanation content as the data generation template with respect to any of following data of the tabular data selected from the group consisting of: a table name, first row data, and first column data; and
determining a question template with a condition as the data generation template with respect to non-first row data other than the table name or non-first column data other than the table name in the tabular data.

5. The method according to claim 1, wherein the determining a data generation template according to the sample data, comprises:
when the first data in the sample data is a title, determining a first data generation template, wherein the first data generation template is a question template for acquiring an explanation content of the first data; and
the determining answer data according to second data other than the first data in the sample data, comprises:
taking a directory content corresponding to the sample data or an abstract content located after the first data in the sample data as the answer data.

6. The method according to claim 1, wherein the determining a data generation template according to the sample data, comprises:
when the first data in the sample data is a concept entity, determining a second data generation template, wherein the second data generation template is a question template for acquiring an explanation content of the first data; and
the determining answer data according to second data other than the first data in the sample data, comprises:
determining the answer data according to a context content of the first data in the sample data.

7. The method according to claim 1, wherein the determining a data generation template according to the sample data, comprises:
when the second data in the sample data is arrayed data, determining a third data generation template,
wherein the third data generation template is a question template for acquiring the arrayed data, and the first data is correspondingly data located before the second data in the sample data.

8. The method according to claim 3, wherein the determining the data generation template according to arrangement information of data in the tabular data, comprises:
determining a question template for acquiring a concept explanation content as the data generation template with respect to any of following data of the tabular data selected from the group consisting of: a table name, first row data, and first column data; and
determining a question template with a condition as the data generation template with respect to non-first row data other than the table name or non-first column data other than the table name in the tabular data.

9. A non-transient computer-readable medium, storing computer programs, wherein when the computer programs are executed by at least one processor, a method of generating training data is implemented, and the method of generating training data comprises:
acquiring sample data;
determining a data generation template according to the sample data;
generating question data according to first data in the sample data and the data generation template, and determining answer data according to second data other than the first data in the sample data; and
combining the question data and the answer data into the training data.

10. The non-transient computer-readable medium according to claim 9, wherein the determining a data generation template according to the sample data, comprises:
when the sample data comprises tabular data, determining the data generation template according to arrangement information of data in the tabular data;
when the sample data comprises text data, determining the data generation template by at least one selected from the group consisting of:
performing semantic recognition on the sample data to obtain a semantic recognition result, and determining the data generation template according to the semantic recognition result; and
performing entity recognition on the sample data through a preset entity recognition model to obtain an entity recognition result, and determining the data generation template according to the entity recognition result.

11. The non-transient computer-readable medium according to claim 10, wherein the determining the data generation template according to the semantic recognition result, comprises:
searching for at least one data generation template carrying a first template identifier in a preset template library according to the semantic recognition result, wherein the preset template library pre-stores a plurality of the data generation templates, and the first template identifier is a preset template identifier matching the semantic recognition result; and
the determining the data generation template according to the entity recognition result, comprises:
searching for at least one data generation template carrying a second template identifier in the preset template library according to the entity recognition result, wherein the second template identifier is a preset template identifier matching the entity recognition result.

12. The non-transient computer-readable medium according to claim 10, wherein the determining the data generation template according to arrangement information of data in the tabular data, comprises:
determining a question template for acquiring a concept explanation content as the data generation template with respect to any of following data of the tabular data selected from the group consisting of: a table name, first row data, and first column data; and
determining a question template with a condition as the data generation template with respect to non-first row data other than the table name or non-first column data other than the table name in the tabular data.

13. The non-transient computer-readable medium according to claim 9, wherein the determining a data generation template according to the sample data, comprises:
when the first data in the sample data is a title, determining a first data generation template, wherein the first data generation template is a question template for acquiring an explanation content of the first data; and
the determining answer data according to second data other than the first data in the sample data, comprises:
taking a directory content corresponding to the sample data or an abstract content located after the first data in the sample data as the answer data.

14. The non-transient computer-readable medium according to claim 9, wherein the determining a data generation template according to the sample data, comprises:
when the first data in the sample data is a concept entity, determining a second data generation template, wherein the second data generation template is a question template for acquiring an explanation content of the first data; and
the determining answer data according to second data other than the first data in the sample data, comprises:
determining the answer data according to a context content of the first data in the sample data.

15. An electronic device, comprising:
a memory, storing computer programs; and
at least one processor, configured to execute the computer programs in the memory to implement a method of generating training data, wherein the method of generating training data comprises:
acquiring sample data;
determining a data generation template according to the sample data;
generating question data according to first data in the sample data and the data generation template, and determining answer data according to second data other than the first data in the sample data; and
combining the question data and the answer data into the training data.

16. The electronic device according to claim 15, wherein the determining a data generation template according to the sample data, comprises:
when the sample data comprises tabular data, determining the data generation template according to arrangement information of data in the tabular data;
when the sample data comprises text data, determining the data generation template by at least one selected from the group consisting of:
performing semantic recognition on the sample data to obtain a semantic recognition result, and determining the data generation template according to the semantic recognition result; and
performing entity recognition on the sample data through a preset entity recognition model to obtain an entity recognition result, and determining the data generation template according to the entity recognition result.

17. The electronic device according to claim 16, wherein the determining the data generation template according to the semantic recognition result, comprises:
searching for at least one data generation template carrying a first template identifier in a preset template library according to the semantic recognition result, wherein the preset template library pre-stores a plurality of the data generation templates, and the first template identifier is a preset template identifier matching the semantic recognition result; and
the determining the data generation template according to the entity recognition result, comprises:
searching for at least one data generation template carrying a second template identifier in the preset template library according to the entity recognition result, wherein the second template identifier is a preset template identifier matching the entity recognition result.

18. The electronic device according to claim 16, wherein the determining the data generation template according to arrangement information of data in the tabular data, comprises:
determining a question template for acquiring a concept explanation content as the data generation template with respect to any of following data of the tabular data selected from the group consisting of: a table name, first row data, and first column data; and
determining a question template with a condition as the data generation template with respect to non-first row data other than the table name or non-first column data other than the table name in the tabular data.

19. The electronic device according to claim 15, wherein the determining a data generation template according to the sample data, comprises:
when the first data in the sample data is a title, determining a first data generation template, wherein the first data generation template is a question template for acquiring an explanation content of the first data; and
the determining answer data according to second data other than the first data in the sample data, comprises:
taking a directory content corresponding to the sample data or an abstract content located after the first data in the sample data as the answer data.

20. The electronic device according to claim 15, wherein the determining a data generation template according to the sample data, comprises:
when the first data in the sample data is a concept entity, determining a second data generation template, wherein the second data generation template is a question template for acquiring an explanation content of the first data; and
the determining answer data according to second data other than the first data in the sample data, comprises:
determining the answer data according to a context content of the first data in the sample data.
